(19) United States
(12) Patent Application Publication
(10) Pub. No.: US 2026/0356737 A1
(43) Pub. Date: Nov. 12, 2026

(54) CRYSTALLIZED GLASS AND THREE-DIMENSIONALLY SHAPED COVER GLASS

(71) Applicant: AGC INC., Tokyo (JP)

(72) Inventors: Hitomi FURUTA, Tokyo (JP); Miyuri SUZUKI, Tokyo (JP); Shigeki SAWAMURA, Tokyo (JP); Seiji INABA, Tokyo (JP)

(73) Assignee: AGC INC., Tokyo (JP)

(21) Appl. No.: 19/718,417

(22) Filed: Jun. 24, 2026

Related U.S. Application Data
(63) Continuation of application No. PCT/JP2024/038474, filed on Oct. 29, 2024.

(30) Foreign Application Priority Data
Dec. 27, 2023 (JP) 2023-221645

(51) Int. Cl. C03C 10/00; C03C 21/00

(52) U.S. Cl. CPC C03C 10/0027; C03C 21/002

(57) ABSTRACT

A crystallized glass having a crystal phase, containing, as a content proportion in terms of mole percentage based on oxides: 55% to 75% of SiO₂; 0.1% to 5% of Al₂O₃; 0.5% to 5% of P₂O₅; 0% to 10% of B₂O₃; 15% to 30% of Li₂O; 0% to 5% of Na₂O; 0% to 3% of K₂O; 2.1% to 10% of ZrO₂; 0% to 5% of TiO₂; 0% to 2% of SnO₂; 0% to 5% of Y₂O₃; and 0% to 5% of MgO, in which the crystallized glass has a haze value of 0.4% or less in terms of a thickness of 0.7 mm, an average transmittance of 85% or more with respect to light having a wavelength range of 380 nm to 780 nm in terms of a thickness of 0.7 mm, and a value represented by the expression (1) of 6 to 500.

### CROSS-REFERENCE TO RELATED APPLICATIONS

This is a continuation of International Application No. PCT/JP2024/038474 filed on Oct. 29, 2024, and claims priority from Japanese Patent Application No. 2023-221645 filed on Dec. 27, 2023, the entire content of which is incorporated herein by reference.

### TECHNICAL FIELD

The present invention relates to a crystallized glass and a three-dimensionally shaped cover glass made of the crystallized glass.

### BACKGROUND ART

As a cover glass of a display device in a mobile device such as a mobile phone or a smart phone, and a cover glass of an in-vehicle display member such as an instrument panel or a head up display (HUD), a chemically strengthened glass, which is thin and has a high strength, is used. In these display devices, a cover glass having a three-dimensional shape (curved surface shape) may be required in order to improve operability and visibility. A three-dimensionally shaped cover glass is produced by a method of heating a flat glass sheet and performing bending (also referred to as a three-dimensional-shape bending or three-dimensional forming) using a forming mold.

As a crystal phase in a crystallized glass applicable as such a three-dimensionally shaped cover glass, a lithium disilicate crystal having a high strength has attracted attention. For example, Patent Literatures 1 and 2 disclose a crystallized glass containing a lithium disilicate crystal and a petalite crystal. Specifically, Patent Literature 1 discloses that a good fracture strength and tensile bending strength of a microcrystalline glass can be realized by using three crystal phases of lithium disilicate, petalite, and β-eucryptite. In addition, Patent Literature 2 discloses that a high mechanical strength and fracture resistance can be realized by a glass ceramic composition containing a lithium disilicate crystal and a petalite crystal.

### CITATION LIST

### Patent Literature

Patent Literature 1: CN111018356B
Patent Literature 2: WO 2016/057748

### SUMMARY OF INVENTION

### Technical Problem

The crystal phase of lithium disilicate can increase the strength of the crystallized glass, but the crystallized glass tends to be whitish because the crystallized glass has a high crystal growth rate. Therefore, in order to realize a high transmittance, in Patent Literature 1 or 2, crystal growth of lithium disilicate is prevented and an average size of crystals is controlled by also including the petalite crystal.

However, the crystallized glass containing the target lithium disilicate crystal and other crystals has a higher crystallinity than a crystallized glass containing the target crystal as a single phase, when the crystallized glasses have the same content proportion of the target crystal, and three-dimensional shape bending becomes difficult. In addition, when the crystallinity is high and each crystal constituting the crystal phase is a crystal in which ion exchange of an alkali metal ion is not performed even when a chemical strengthening treatment is performed, a proportion of the alkali metal ion capable of the ion exchange in the crystallized glass is reduced, and the chemical strengthening treatment is difficult to perform.

In addition, the crystallized glass containing the target crystal and other crystals has a lower strength than a crystallized glass containing the target crystal as a single phase, when the crystallized glasses have the same crystallinity, due to the presence of the other crystals.

Therefore, an object of the present invention is to provide a crystallized glass that achieves both a high strength and high three-dimensional formability while realizing a high transmittance and a small haze value, and that also has excellent chemical strengthening treatability. Another object of the present invention is to provide a three-dimensionally shaped cover glass made of the above crystallized glass.

### Solution to Problem

As a result of intensive studies on the above problems, the present inventors have found that, by setting a composition of a crystallized glass within a specific range and setting content proportions of SiO₂, Li₂O, and Al₂O₃ and a total content proportion of thickening components to satisfy a specific relationship, even a crystal originally having a high crystal growth rate can have a low crystal growth rate and can be a minute crystal. As a result, it has been found that a crystallized glass having a high transmittance and a small haze value can be obtained, and the present invention has been completed.

That is, the present invention relates to the following [1] to [11].

[1] A crystallized glass having a crystal phase, containing, as a content proportion in terms of mole percentage based on oxides:
55% to 75% of SiO₂;
0.1% to 5% of Al₂O₃;
0.5% to 5% of P₂O₅;
0% to 10% of B₂O₃;
15% to 30% of Li₂O;
0% to 5% of Na₂O;
0% to 3% of K₂O;
2.1% to 10% of ZrO₂;
0% to 5% of TiO₂;
0% to 2% of SnO₂;
0% to 5% of Y₂O₃; and
0% to 5% of MgO, in which
the crystallized glass has a haze value of 0.4% or less in terms of a thickness of 0.7 mm, an average transmittance of 85% or more with respect to light having a wavelength range of 380 nm to 780 nm in terms of a thickness of 0.7 mm, and a value represented by the following expression (1) of 6 to 500,

$$\begin{matrix}[ Math . 1 ] & \\ \frac{500}{\{ \begin{matrix}\vert \frac{[ {SiO}_{2} ]}{[ LAS ]} \times 100 - 66.7 \vert \times \vert \frac{[ {Li}_{2} O ]}{[ LAS ]} \times 100 - 33.3 \vert \times \\ ( \frac{[ {Al}_{2} {O}_{3} ]}{[ LAS ]} \times 100 )\end{matrix} \}} + [ A ] & ( 1 )\end{matrix}$$

where in the expression (1), [SiO₂], [Li₂O], and [Al₂O₃] respectively represent the content proportions (mol %) of SiO₂, Li₂O, and Al₂O₃ in the crystallized glass, [LAS] represents a total content proportion (mol %) of SiO₂, Li₂O, and Al₂O₃ in the crystallized glass, and [A] represents a total content proportion (mol %) of a thickening component in the crystallized glass.

[2] The crystallized glass according to the above [1], satisfying a relationship of 66≤[{[SiO₂]/([SiO₂]+[Al₂O₃]+[Li₂O])}×100] (%)≤77, where [SiO₂], [Li₂O], and [Al₂O₃] respectively represent the content proportions of SiO₂, Li₂O, and Al₂O₃ in the crystallized glass in terms of mole percentage based on oxides.

[3] The crystallized glass according to the above [1] or [2], satisfying a relationship of 1≤[{[Al₂O₃]/([SiO₂]+[Al₂O₃]+[Li₂O])}×100] (%)≤5, where [SiO₂], [Li₂O], and [Al₂O₃] respectively represent the content proportions of SiO₂, Li₂O, and Al₂O₃ in the crystallized glass in terms of mole percentage based on oxides.

[4] The crystallized glass according to any one of the above [1] to [3], in which the crystal phase contains a Li₂Si₂O₅ crystal, and has a content proportion of the Li₂Si₂O₅ crystal being 50 vol % or more.

[5] The crystallized glass according to the above [4], in which the crystal phase has a content proportion of a crystal other than the Li₂Si₂O₅ crystal being 20 vol % or less.

[6] The crystallized glass according to any one of the above [1] to [5], containing: a Li ion capable of ion exchange with a Na ion when the crystallized glass is immersed in a molten salt containing the Na ion.

[7] The crystallized glass according to any one of the above [1] to [5], in which a content proportion of Na₂O on a surface of the crystallized glass is greater than a content proportion of Na₂O at a thickness center of the crystallized glass in terms of mole percentage based on oxides, and a difference between the content proportion of Na₂O on the surface of the crystallized glass and the content proportion of Na₂O at the thickness center of the crystallized glass is 1% or more.

[8] The crystallized glass according to the above [7], having a surface compressive stress of 500 MPa or more and a depth of compressive stress layer of 70 μm or more.

[9] The crystallized glass according to the above [7] or [8], having a fracture toughness value of 0.8 MPa·m^{1/2} or more.

[10] The crystallized glass according to any one of the above [7] to [9], having a value of ST limit obtained by the following test method being 10,000 MPa·μm to 300,000 MPa·μm,

### Test Method:

as a test glass sheet, a glass sheet having a 15 mm square and a thickness of 0.7 mm and having a mirror-finished surface is subjected to a chemical strengthening treatment under various conditions to prepare a plurality of test glass sheets having different ST values which are tensile stress integral values; using a Vickers tester, a diamond indenter with a tip angle of 90° is driven into a central portion of the test glass sheet to fracture the glass sheet, and the number of broken pieces is defined as a fragmentation number, in a case where the glass sheet is not cracked after a test is started with a driving load of the diamond indenter of 1 kgf, the driving load is increased by 1 kgf each time, the test is repeated until the glass sheet is cracked, and the fragmentation number when the glass sheet is cracked for the first time is counted; and the fragmentation number is plotted with respect to an ST value of the test glass sheet, and an ST value at which the fragmentation number is 10 is read and is regarded as the ST limit.

[11] A three-dimensionally shaped cover glass containing:
the crystallized glass according to any one of the above [1] to [10], in which
the crystallized glass has a three-dimensional shape including a curved surface portion forming a three-dimensional curved surface.

### Advantageous Effects of Invention

According to the present invention, it is possible to obtain a crystallized glass that achieves both a high strength and high three-dimensional formability while realizing a high transmittance and a small haze value, and that also has excellent chemical strengthening treatability.

A three-dimensionally shaped cover glass obtained by imparting a curved surface portion having a three-dimensional curved surface to the crystallized glass is suitable as a cover glass of a display device in a mobile device such as a mobile phone or a smart phone, or of an in-vehicle display member such as an instrument panel or a HUD.

### DESCRIPTION OF EMBODIMENTS

Hereinafter, an embodiment of the present invention will be described. The present invention is not limited to the following embodiments.

In addition, in the present description, “to” indicating a numerical range is used in the sense of including the numerical values set forth before and after the “to” as a lower limit value and an upper limit value.

### <<Crystallized Glass>>

A crystallized glass according to the present embodiment has a crystal phase. In addition, content proportions in terms of mole percentage based on oxides preferably satisfy the following:
55% to 75% of SiO₂;
0.1% to 5% of Al₂O₃;
0.5% to 5% of P₂O₅;
0% to 10% of B₂O₃;
15% to 30% of Li₂O;
0% to 5% of Na₂O;
0% to 3% of K₂O;
2.1% to 10% of ZrO₂;
0% to 5% of TiO₂;
0% to 2% of SnO₂;
0% to 5% of Y₂O₃; and
0% to 5% of MgO.

Here, the crystallized glass having a crystal phase in the present description means a glass in which a diffraction peak indicating a crystal is observed in an X-ray diffraction (XRD) pattern obtained by using a powder XRD method. The crystallized glass is obtained by subjecting, to a heat treatment, an amorphous glass in which a diffraction peak indicating a crystal is not observed to precipitate a crystal.

Note that, in the XRD measurement, measurement is performed in a range of 20 of 10° to 80° using CuKα rays, and in the case where a diffraction peak appears, a crystal structure of a crystal constituting the crystal phase can be identified by identifying the precipitated crystal by, for example, Hanawalt method.

In addition, in the present description, the composition of the crystallized glass can be identified using a known method. For example, it can be identified by wet chemical analysis or quantitative analysis using a calibration curve of fluorescent X-rays.

In addition, a composition of the amorphous glass before precipitation of crystals and the composition of the crystallized glass according to the present embodiment in which crystals are precipitated can be regarded as the same.

Further, in the present description, the crystallized glass that has been subjected to a chemical strengthening treatment is referred to as a “chemically strengthened glass”, and a base composition of the chemically strengthened glass can be regarded as the same as the composition of the crystallized glass before the chemical strengthening treatment, and a composition of a portion deeper than a depth of compressive stress layer (DOL) of the chemically strengthened glass can be regarded as the same as the base composition of the chemically strengthened glass except for the case where an extreme ion exchange treatment is performed. That is, a thickness center composition of the chemically strengthened glass coincides with the base composition of the chemically strengthened glass.

In addition, in the crystallized glass according to the present embodiment, a value represented by the following expression (1) is preferably 6 to 500, where [SiO₂], [Li₂O], and [Al₂O₃] respectively represent the content proportions (mol %) of SiO₂, Li₂O, and Al₂O₃ in the crystallized glass, [LAS] represents a total content proportion (mol %) of SiO₂, Li₂O, and Al₂O₃, and [A] represents a total content proportion (mol %) of a thickening component.

Here, examples of the thickening component include ZrO₂, Y₂O₃, TiO₂, and SnO₂. Therefore, the total content proportion of the thickening component means a total content proportion represented by {[ZrO₂]+[Y₂O₃]+[TiO₂]+[SnO₂]}, where [ZrO₂], [Y₂O₃], [TiO₂], and [SnO₂] respectively represent the content proportions (mol %) of ZrO₂, Y₂O₃, TiO₂, and SnO₂.

$$\begin{matrix}[ Math . 2 ] & \\ \frac{500}{\{ \begin{matrix}\vert \frac{[ {SiO}_{2} ]}{[ LAS ]} \times 100 - 66.7 \vert \times \vert \frac{[ {Li}_{2} O ]}{[ LAS ]} \times 100 - 33.3 \vert \times \\ ( \frac{[ {Al}_{2} {O}_{3} ]}{[ LAS ]} \times 100 )\end{matrix} \}} + [ A ] & ( 1 )\end{matrix}$$

The crystallized glass according to the present embodiment preferably has a haze value of 0.4% or less in terms of a thickness of 0.7 mm, preferably has an average transmittance of 85% or more with respect to light having a wavelength range of 380 nm to 780 nm in terms of a thickness of 0.7 mm, and more preferably satisfies both the haze value and the average transmittance, in view of an application to a cover glass, particularly to an application to a three-dimensionally shaped cover glass.

Here, the haze value is a value obtained in accordance with JIS K3761:2000 using a C light source. In addition, the average transmittance with respect to the light having a wavelength range of 380 nm to 780 nm means a linear transmittance.

Hereinafter, the crystallized glass is described in detail.

### <Composition and Crystal>

The composition of the crystallized glass according to the present embodiment preferably satisfies the following:
55% to 75% of SiO₂;
0.1% to 5% of Al₂O₃;
0.5% to 5% of P₂O₅;
0% to 10% of B₂O₃;
15% to 30% of Li₂O;
0% to 5% of Na₂O;
0% to 3% of K₂O;
2.1% to 10% of ZrO₂;
0% to 5% of TiO₂;
0% to 2% of SnO₂;
0% to 5% of Y₂O₃; and
0% to 5% of MgO.

The above composition is a glass generally referred to as a Li₂O—Al₂O₃—SiO₂-based glass, and is a composition that easily achieves a high strength by ion exchange between Li ions in the glass and Na ions in a molten salt by a chemical strengthening treatment.

One of factors that determine a crystal species constituting the crystal phase in the crystallized glass is a ratio of Li₂O, Al₂O₃, and SiO₂. In the present description, a crystal containing SiO₂, Al₂O₃, and Li₂O, a crystal containing SiO₂ and Li₂O, and a crystal containing SiO₂ and Al₂O₃ may be collectively referred to as an LAS crystal.

Examples of the crystal species of the crystallized glass obtained from the above Li₂O—Al₂O₃—SiO₂-based glass include a β-spodumene crystal (LiAlSi₂O₆), lithium disilicate (Li₂Si₂O₅), petalite (LiAlSi₄O₁₀), β-quartz (including bergerite) (LiₓAlₓSi₃₋ₓO₆), lithium metasilicate (Li₂SiO₃), eucryptite (LiAlSiO₄), and mullite (Al₄₊₂ₓSi₂₋₂ₓO₁₀₋ₓ, 0.2≤×≤0.5).

The crystal species in the crystallized glass according to the present embodiment may be appropriately selected in accordance with desired properties.

For example, when it is desired to obtain a crystal phase capable of ion exchange by a chemical strengthening treatment, lithium disilicate, a β-spodumene crystal, petalite, β-quartz, and lithium metasilicate are preferred, lithium disilicate, a β-spodumene crystal, and lithium metasilicate are more preferred, and lithium disilicate and a β-spodumene crystal are still more preferred.

When it is desired to obtain a high strength crystallized glass, a β-spodumene crystal, lithium disilicate, petalite, β-quartz, lithium metasilicate, and mullite are preferred, and lithium disilicate and mullite are more preferred.

When it is desired to obtain a crystallized glass having high transmissibility and a small haze value, β-quartz and lithium metasilicate are preferred. However, when the crystallized glass according to the present embodiment has a composition satisfying the above expression (1), high transmissibility and a small haze value can be realized even with crystal species such as a β-spodumene crystal, lithium disilicate, and eucryptite, which have a high crystal growth rate and are considered to be difficult to realize high transmissibility and a small haze value in the related art.

Crystallinity of the crystallized glass according to the present embodiment, that is, a content proportion of the crystal phase is preferably 20 vol % to 90 vol %, more preferably 25 vol % to 85 vol %, still more preferably 30 vol % to 83 vol %, and even more preferably 35 vol % to 80 vol %. Here, the crystallinity is preferably 20 vol % or more, more preferably 25 vol % or more, still more preferably 30 vol % or more, and even more preferably 35 vol % or more, from the viewpoint of increasing a mechanical strength of the crystallized glass. In addition, the crystallinity is preferably 90 vol % or less, more preferably 85 vol % or less, still more preferably 83 vol % or less, and even more preferably 80 vol % or less, from the viewpoint of maintaining a high transmittance and a small haze value and from the viewpoint of the three-dimensional formability. In addition, in the case where the crystal phase contains two or more kinds of crystals, a total thereof preferably satisfies the above range.

Note that, the crystallinity in the present description can be calculated by the Rietveld method based on a diffraction intensity of an XRD pattern obtained by powder X-ray diffraction (XRD) measurement. The Rietveld method is described in “Crystal Analysis Handbook” edited by the Crystallographic Society of Japan and “Crystal Analysis Handbook” (Kyoritsu Shuppan, 1999, p492 to 499).

The crystal constituting the crystal phase of the crystallized glass according to the present embodiment has an average grain diameter (crystallite size) of preferably 300 nm or less, more preferably 200 nm or less, still more preferably 150 nm or less, and even more preferably 100 nm or less, from the viewpoint of realizing a higher transmittance and a smaller haze value.

Note that, the crystallite size of the crystal in the present description can be calculated by the Rietveld method based on a diffraction intensity of an XRD pattern obtained by XRD measurement.

The crystal phase of the crystallized glass according to the present embodiment preferably contains a crystal of lithium disilicate (Li₂Si₂O₅), for example, from the viewpoint of obtaining a high strength crystallized glass while overcoming problems such as difficulty in realizing high transmissibility and a low haze value, in the related art.

In this case, a content proportion of the lithium disilicate crystal in the crystal phase is preferably 50 vol % or more, more preferably 50 vol % to 100 vol %, still more preferably 60 vol % to 100 vol %, even more preferably 70 vol % to 100 vol %, even still more preferably 80 vol % to 100 vol %, and particularly preferably 90 vol % to 100 vol %. Here, from the viewpoint of further increasing the strength of the crystallized glass, the content proportion thereof is preferably 50 vol % or more, more preferably 60 vol % or more, still more preferably 70 vol % or more, even more preferably 80 vol % or more, particularly preferably 90 vol % or more, and may be 100 vol %, that is, the crystal phase may be a single phase of the lithium disilicate crystal.

However, the crystal phase in the present embodiment does not exclude at all a crystal phase containing a crystal other than the lithium disilicate crystal. In the case where the crystal phase in the present embodiment contains a crystal other than the lithium disilicate crystal, a content proportion of the lithium disilicate crystal may be, for example, 99 vol % or less, 95 vol % or less, 90 vol % or less, or 80 vol % or less.

That is, in the case where the crystal phase of the crystallized glass according to the present embodiment contains the lithium disilicate crystal, a total content proportion of crystals other than the lithium disilicate crystal is preferably 50 vol % or less, more preferably 20 vol % or less, still more preferably 0 vol % to 20 vol %, and even more preferably 0 vol % to 10 vol %. Here, from the viewpoint of more suitably obtaining the effect of lithium disilicate, the total content proportion of the other crystals is preferably 50 vol % or less, more preferably 20 vol % or less, still more preferably 10 vol % or less, and may be 0 vol %, that is, a single phase of lithium disilicate. However, when it is desired to obtain the effect of the other crystals, the total content proportion of the other crystals may be 1 vol % or more, 5 vol % or more, 10 vol % or more, or 20 vol % or more.

The other crystals may be LAS crystals other than lithium disilicate, or may be crystals other than the LAS crystals.

Examples of the crystals other than the LAS crystals include lithium phosphate and SiO₂.

The composition of the crystallized glass according to the present embodiment may be such that desired crystals as described above can be obtained, and each component is specifically described.

SiO₂ is a component that constitutes a glass network and is also a component that constitutes the LAS crystal.

The content proportion of SiO₂ is preferably 55% to 75%, more preferably 57% to 73%, and still more preferably 59% to 71%. Here, the content proportion thereof is preferably 55% or more, more preferably 57% or more, still more preferably 58% or more, even more preferably 59% or more, and particularly preferably 61% or more, from the viewpoint of easily forming the lithium disilicate crystal. In addition, the content proportion thereof is preferably 75% or less, more preferably 73% or less, and still more preferably 71% or less, from the viewpoint of improving meltability of the glass.

Al₂O₃ is not only a constituent component of the LAS crystal, but also a component that improves an ion exchange property during a chemical strengthening treatment and that increases the surface compressive stress after the chemical strengthening treatment.

The content proportion of Al₂O₃ is preferably 0.1% to 5%, more preferably 0.5% to 4.5%, and still more preferably 1% to 4%. Here, the content proportion thereof is preferably 0.1% or more, more preferably 0.5% or more, still more preferably 1% or more, and even more preferably 2% or more, from the viewpoint of suitably performing the chemical strengthening treatment. In addition, the content proportion thereof is preferably 5% or less, more preferably 4.5% or less, and still more preferably 4% or less, from the viewpoint of easily forming the lithium disilicate crystal.

P₂O₅ is a component that promotes crystallization.

The content proportion of P₂O₅ is preferably 0.5% to 5%, more preferably 0.8% to 4.5%, and still more preferably 1% to 4%. Here, the content proportion thereof is preferably 0.5% or more, more preferably 0.8% or more, still more preferably 1% or more, and even more preferably 2% or more, from the viewpoint of facilitating the crystallization. In addition, the content proportion thereof is preferably 5% or less, more preferably 4.5% or less, still more preferably 4% or less, and even more preferably 2% or less, from the viewpoint of preventing phase separation during melting and a decrease in acid resistance.

B₂O₃ is a component that improves chipping resistance and the meltability.

The content proportion of B₂O₃ is preferably 0% to 10%, more preferably 0.1% to 9%, and still more preferably 0.2% to 8%. Here, B₂O₃ may not be contained, but in the case of being contained, the content proportion thereof is preferably 0.1% or more, and more preferably 0.2% or more, from the viewpoint of obtaining good chipping resistance and meltability. In addition, the content proportion thereof is preferably 10% or less, more preferably 9% or less, and still more preferably 8% or less, from the viewpoint of preventing the occurrence of striae and the phase separation during melting and maintaining a quality of the crystallized glass.

Li₂O is a component that forms a compressive stress near the surface of the glass by ion exchange with Na ions, and is also a constituent component of the lithium disilicate crystal.

The content proportion of Li₂O is preferably 15% to 30%, more preferably 17% to 27%, and still more preferably 20% to 25%. Here, the content proportion thereof is preferably 15% or more, more preferably 17% or more, and still more preferably 20% or more, from the viewpoint of increasing the compressive stress. In addition, the content proportion thereof is preferably 30% or less, more preferably 27% or less, and still more preferably 25% or less, from the viewpoint of chemical durability of the glass.

Na₂O is a component that forms a compressive stress by ion exchange with K ions, and when contained in a small amount, may improve stability of the glass.

The content proportion of Na₂O is preferably 0% to 5%, more preferably 0.5% to 4.5%, still more preferably 1% to 4%, and even more preferably 1.5% to 3.5%. Here, in the case of containing Na₂O, the content proportion thereof is preferably 0.5% or more, more preferably 1% or more, and still more preferably 1.5% or more, from the viewpoint of increasing the compressive stress and improving the stability. In addition, the content proportion thereof is preferably 5% or less, more preferably 4.5% or less, still more preferably 4% or less, and even more preferably 3.5% or less, from the viewpoint of maintaining the chemical durability.

K₂O is a component that improves chemical strengthening properties and that prevents the phase separation.

The content proportion of K₂O is preferably 0% to 3%, more preferably 0.1% to 2%, and still more preferably 0.3% to 1%. Here, in the case of containing K₂O, the content proportion thereof is preferably 0.1% or more, more preferably 0.3% or more, and still more preferably 0.5% or more, from the viewpoint of improving the stability of the glass. In addition, the content proportion thereof is preferably 3% or less, more preferably 2% or less, and still more preferably 1% or less, from the viewpoint of maintaining the chemical durability.

ZrO₂ is a thickening component that increases a viscosity during melting, and is also a component that increases the surface compressive stress due to ion exchange.

The content proportion of ZrO₂ is preferably 2.1% to 10%, more preferably 2.5% to 9%, and still more preferably 3% to 8%. Here, the content proportion thereof is preferably 2.1% or more, more preferably 2.5% or more, and still more preferably 3% or more, from the viewpoint of realizing a high transmittance and a small haze value of the crystallized glass by acting as a thickening component, by slowing down the growth rate of a crystal to be a crystal phase, and by forming a minute crystal. In addition, the content proportion thereof is preferably 10% or less, more preferably 9% or less, and still more preferably 8% or less, from the viewpoint of preventing devitrification during melting.

TiO₂ is a thickening component that increases the viscosity during melting, and is also a component that improves UV resistance.

The content proportion of TiO₂ is preferably 0% to 5%, more preferably 0.1% to 4%, and still more preferably 0.5% to 3%. Here, in the case of containing TiO₂, the content proportion thereof is preferably 0.1% or more, and more preferably 0.5% or more, from the viewpoint of realizing a high transmittance and a small haze value of the crystallized glass by acting as a thickening component, by slowing down the growth rate of a crystal to be a crystal phase, and by forming a minute crystal. In addition, the content proportion thereof is preferably 5% or less, more preferably 4% or less, and still more preferably 3% or less, from the viewpoint of preventing an increase in haze value due to coloring.

SnO₂ is a thickening component that increases the viscosity during melting, and is also a component that generates a crystal nucleus.

The content proportion of SnO₂ is preferably 0% to 2%, more preferably 0.1% to 1.5%, and still more preferably 0.5% to 1%. Here, in the case of containing SnO₂, the content proportion thereof is preferably 0.1% or more, and more preferably 0.5% or more, from the viewpoint of realizing a high transmittance and a small haze value of the crystallized glass by acting as a thickening component, by slowing down the growth rate of a crystal to be a crystal phase, and by forming a minute crystal. In addition, the content proportion thereof is preferably 2% or less, more preferably 1.5% or less, and still more preferably 1% or less, from the viewpoint of preventing defects caused by unmelted substances.

Y₂O₃ is a thickening component that increases the viscosity during melting, and is also a component that prevents scattering of fragments when the glass is fractured. It is also a component that increases a refractive index.

The content proportion of Y₂O₃ is preferably 0% to 5%, more preferably 0.1% to 4%, and still more preferably 0.5% to 3%. Here, in the case of containing Y₂O₃, the content proportion thereof is preferably 0.1% or more, and more preferably 0.5% or more, from the viewpoint of realizing a high transmittance and a small haze value of the crystallized glass by acting as a thickening component, by slowing down the growth rate of a crystal to be a crystal phase, and by forming a minute crystal. In addition, the content proportion thereof is preferably 5% or less, more preferably 4% or less, and still more preferably 3% or less, from the viewpoint of preventing the devitrification during melting.

Both ZrO₂, TiO₂, SnO₂, and Y₂O₃ are thickening components. The total content proportion of ZrO₂, TiO₂, SnO₂, and Y₂O₃ (hereinafter, also referred to as [A]) is preferably 2.1% to 10%, more preferably 3% to 9%, and still more preferably 4% to 8%. Here, the content proportion thereof is preferably 2.1% or more, more preferably 2.5% or more, still more preferably 3% or more, and even more preferably 4% or more, from the viewpoint of realizing a high transmittance and a small haze value of the crystallized glass by acting as a thickening component, by slowing down the growth rate of a crystal to be a crystal phase, and by forming a minute crystal. In addition, the content proportion thereof is preferably 10% or less, more preferably 9% or less, and still more preferably 8% or less, from the viewpoint of the meltability.

MgO is a component that improves the meltability of the glass.

The content proportion of MgO is preferably 0% to 5%, more preferably 0.1% to 4%, and still more preferably 0.5% to 3%. Here, in the case of containing MgO, the content proportion thereof is preferably 0.1% or more, and more preferably 0.5% or more, from the viewpoint of increasing the strength of the glass. In addition, the content proportion thereof is preferably 5% or less, more preferably 4% or less, and still more preferably 3% or less, from the viewpoint of maintaining a good ion exchange performance.

CaO, SrO, and BaO, which are alkaline earth metals other than MgO, are also components that improve the meltability of the glass, similar to MgO.

The total content proportion of MgO, CaO, SrO, and BaO is preferably 0% to 5%, more preferably 0.1% to 4%, and still more preferably 0.5% to 3%. Here, in the case of containing the alkaline earth metal, the total content proportion is preferably 0.1% or more, and more preferably 0.5% or more, from the viewpoint of increasing the strength of the glass. In addition, the total content proportion is preferably 5% or less, more preferably 4% or less, and still more preferably 3% or less, from the viewpoint of maintaining a good ion exchange performance.

In addition, the content proportion of each of CaO, SrO, and BaO is preferably 0% to 4%, more preferably 0.1% to 3%, still more preferably 0.5% to 3%, even more preferably 1% to 2.5%, and particularly preferably 1% to 2%. Here, when the crystallized glass contains at least one selected from the group consisting of CaO, SrO, and BaO, the content proportion of each of them is preferably 0.1% or more, more preferably 0.5% or more, and still more preferably 1% or more, from the viewpoint of improving the stability of the glass. In addition, the content proportion of each of them is preferably 4% or less, more preferably 3% or less, still more preferably 2.5% or less, and even more preferably 2% or less, from the viewpoint of maintaining a good ion exchange performance.

Similar to Y₂O₃, La₂O₃, Nb₂O₅, and Ta₂O₅ have an effect of preventing scattering of fragments when the glass is fractured, and may be contained in order to increase the refractive index.

The total content proportion of La₂O₃, Nb₂O₅, and Ta₂O₅ is preferably 0% to 3%, and more preferably 0.5% to 2%. Here, these components may not be contained, but in the case of being contained, the total content proportion thereof is preferably 0.5% or more from the viewpoint of increasing the refractive index. In addition, the total content proportion thereof is preferably 3% or less, and more preferably 2% or less, from the viewpoint of preventing the devitrification of the glass during melting.

CeO₂ has an effect of oxidizing the glass, and in the case where the crystallized glass contains a large amount of SnO₂, CeO₂ may prevent coloring by preventing reduction of SnO₂ to SnO, which is a coloring component.

The content proportion of CeO₂ is preferably 0% to 1.5%, more preferably 0.03% to 1.5%, still more preferably 0.05% to 1%, and even more preferably 0.07% to 1%. Here, CeO₂ may not be contained, but in the case of being contained, the content proportion thereof is preferably 0.03% or more, more preferably 0.05% or more, and still more preferably 0.07% or more, from the viewpoint of preventing coloring due to SnO. In addition, the content proportion thereof is preferably 1.5% or less, and more preferably 1% or less, from the viewpoint of preventing coloring of the glass due to excessive CeO₂.

Further, a coloring component may be added within a range that does not inhibit the achievement of desired properties of the crystallized glass. Examples of the coloring component include Co₃O₄, MnO₂, Fe₂O₃, NiO, CuO, Cr₂O₃, V₂O₅, Bi₂O₃, SeO₂, Er₂O₃, and Nd₂O₃.

The total content proportion of the coloring components is preferably in a range of 1% or less. In the case where it is desired to further increase a light transmittance of the crystallized glass, these components are preferably not substantially contained.

Note that, in the present description, “not substantially contained” means that a component has a content equal to or less than an impurity level contained in raw materials and the like, that is, the component is not intentionally added. In the present description, in the case where it is described that a certain component is not substantially contained, the content proportion of the component is specifically, for example, less than 0.03%.

In addition, SO₃, a chloride, a fluoride, and the like may be appropriately contained as a refining agent in melting of the glass. As₂O₃ is preferably not contained. In the case where Sb₂O₃ is contained, the content proportion thereof is preferably 0.3% or less and more preferably 0.1% or less. It is most preferable that Sb₂O₃ is not substantially contained.

Among the above components, the total content proportion of SiO₂, Li₂O, Al₂O₃, and ZrO₂, TiO₂, SnO₂, and Y₂O₃, which are thickening components, preferably satisfies a value represented by the following expression (1) of 6 to 500.

In the expression (1), [SiO₂], [Li₂O], and [Al₂O₃] respectively represent the content proportions (mol %) of SiO₂, Li₂O, and Al₂O₃ in the crystallized glass. [LAS] represents the total content proportion (mol %) of SiO₂, Li₂O, and Al₂O₃ in the crystallized glass. [A] represents the total content proportion (mol %) of the thickening components in the crystallized glass, that is, the total content proportion of ZrO₂, TiO₂, SnO₂, and Y₂O₃.

$$\begin{matrix}[ Math . 3 ] & \\ \frac{500}{\{ \begin{matrix}\vert \frac{[ {SiO}_{2} ]}{[ LAS ]} \times 100 - 66.7 \vert \times \vert \frac{[ {Li}_{2} O ]}{[ LAS ]} \times 100 - 33.3 \vert \times \\ ( \frac{[ {Al}_{2} {O}_{3} ]}{[ LAS ]} \times 100 )\end{matrix} \}} + [ A ] & ( 1 )\end{matrix}$$

The value represented by the expression (1) is preferably 6 to 500, more preferably 6.2 to 450, still more preferably 6.5 to 400, and even more preferably 6.7 to 350.

Here, in the expression (1), the first term:

$$\begin{matrix}[ Math . 4 ] & \\ \frac{500}{\{ \begin{matrix}\vert \frac{[ {SiO}_{2} ]}{[ LAS ]} \times 100 - 66.7 \vert \times \vert \frac{[ {Li}_{2} O ]}{[ LAS ]} \times 100 - 33.3 \vert \times \\ ( \frac{[ {Al}_{2} {O}_{3} ]}{[ LAS ]} \times 100 )\end{matrix} \}} + [ A ] & \end{matrix}$$

represents the ease of precipitation of the lithium disilicate crystal, and the second term [A] represents the total content proportion of the thickening components.

Accordingly, the value represented by the expression (1) means the ease of precipitation of lithium disilicate having a small particle diameter, and the greater the value represented by the expression (1), the easier it is to obtain lithium disilicate having a small particle diameter.

Note that, 66.7 and 33.3 in the denominator of the first term mean the molar ratios of SiO₂ and Li₂O constituting lithium disilicate (Li₂Si₂O₅), respectively. In addition, 500, which is the numerator of the first term, is an optimal numerical value reached as a result of studies conducted by the present inventors in order to achieve a balance with the total content proportion of the thickening components represented by [A] in obtaining the lithium disilicate crystal.

Based on the above, the value represented by the expression (1) is preferably 6 or more, more preferably 6.2 or more, still more preferably 6.5 or more, and even more preferably 6.7 or more, from the viewpoint of precipitation of the lithium disilicate crystal. In addition, the value represented by the expression (1) is preferably 500 or less, more preferably 450 or less, still more preferably 400 or less, and even more preferably 350 or less, and may be 300 or less, 250 or less, 200 or less, 150 or less, 100 or less, or 50 or less, since when the composition of the crystallized glass is too close to the composition of the lithium disilicate crystal, the growth of the crystal is fast and causes deterioration in haze.

A value represented by [{[SiO₂]/([SiO₂]+[Al₂O₃]+[Li₂O])}×100] (%), that is, {([SiO₂]/[LAS])×100} (%) using the content proportions of SiO₂, Li₂O, and Al₂O₃ in terms of mole percentage based on oxides is preferably 66% to 77%, more preferably 68% to 75%, and still more preferably 70% to 73%. Here, the value is preferably 66% or more, more preferably 68% or more, and still more preferably 70% or more, from the viewpoint of precipitating the lithium disilicate crystal. In addition, the value is preferably 77% or less, more preferably 75% or less, and still more preferably 73% or less, from the viewpoint of precipitating the lithium disilicate crystal.

A value represented by [{[Al₂O₃]/([SiO₂]+[Al₂O₃]+[Li₂O])}×100] (%), that is, {([Al₂O₃]/[LAS])×100} (%) using the content proportions of SiO₂, Li₂O, and Al₂O₃ in terms of mole percentage based on oxides is preferably 1% to 5%, more preferably 1.5% to 4.5%, and still more preferably 2% to 4%. Here, the value is preferably 1% or more, more preferably 1.5% or more, and still more preferably 2% or more, from the viewpoint of precipitating the lithium disilicate crystal. In addition, the value is preferably 5% or less, more preferably 4.5% or less, and still more preferably 4% or less, from the viewpoint of precipitating the lithium disilicate crystal.

A value represented by [{[Li₂O]/([SiO₂]+[Al₂O₃]+[Li₂O])}×100] (%), that is, {([Li₂O]/[LAS])×100} (%) using the content proportions of SiO₂, Li₂O, and Al₂O₃ in terms of mole percentage based on oxides is preferably 20% to 30%, more preferably 21% to 29%, and still more preferably 22% to 28%. Here, the value is preferably 20% or more, more preferably 21% or more, and still more preferably 22% or more, from the viewpoint of precipitating the lithium disilicate crystal. In addition, the value is preferably 30% or less, more preferably 29% or less, and still more preferably 28% or less, from the viewpoint of precipitating the lithium disilicate crystal.

The crystallized glass according to the present embodiment preferably contains a Li ion capable of ion exchange with a Na ion in a molten salt containing the Na ion when the crystallized glass is immersed in the molten salt. This means that the crystallized glass can be subjected to a chemical strengthening treatment.

Such a Li ion corresponds to Li in the glass phase of the crystallized glass, and also corresponds to Li in the crystal phase depending on the crystal species. Examples of the crystal species containing a Li ion capable of ion exchange include LAS crystals such as lithium disilicate, a β-spodumene crystal, lithium metasilicate, petalite, and β-quartz, and among them, lithium disilicate, a β-spodumene crystal, and lithium metasilicate are preferred.

In addition to the above, the Na ion contained in the crystallized glass by the ion exchange may be further ion-exchanged with a K ion by immersing the crystallized glass in a molten salt containing a K ion.

In addition, the crystallized glass before the chemical strengthening treatment may contain a Na ion capable of ion exchange with a K ion in a molten salt containing the K ion when the crystallized glass is immersed in the molten salt.

### <Physical Properties>

The crystallized glass according to the present embodiment includes both a glass before the chemical strengthening treatment and a glass after the chemical strengthening treatment. In addition, before and after the chemical strengthening treatment, there is no great change in the composition and the crystallinity of the entire crystallized glass, and the physical properties other than the physical properties relating to the strength, and they in the two glasses may be regarded as the same. However, near the surface of the crystallized glass, the composition, the crystal structure, and the crystallinity may be different.

Examples of the physical properties relating to the strength include a surface compressive stress (CS), a depth of compressive stress layer (DOL), an internal tensile stress (CT), a ST limit, a fracture toughness value, a Young's modulus, and Vickers hardness.

On the other hand, examples of the physical properties other than the physical properties relating to the strength include a haze value, an average transmittance, and an average thermal expansion coefficient.

Further, when the crystallized glass is bent into a three-dimensional shape to form a three-dimensionally shaped cover glass, there is no great change in composition, crystallinity, and physical properties of the entire crystallized glass, and these in the three-dimensionally shaped cover glass may be regarded as the same as those in a flat-sheet-shaped crystallized glass before three-dimensional shape bending.

In the crystallized glass according to the present embodiment that has been subjected to the chemical strengthening treatment, for example, it is preferable that the content proportion of Na₂O on the surface of the crystallized glass is higher than the content proportion of Na₂O at a thickness center of the crystallized glass, and it is more preferable that a difference between the content proportion of Na₂O on the surface of the crystallized glass and the content proportion of Na₂O at the thickness center of the crystallized glass is 1% or more. The above is an example of a chemically strengthened crystallized glass after ion exchange between the Li ion in the crystallized glass and the Na ion in the molten salt.

The difference thereof is more preferably 5% or more, and still more preferably 10% or more. The upper limit of the difference between the content proportions of Na₂O is not particularly limited, and is, for example, 30% or less.

The surface compressive stress (CS) of the crystallized glass according to the present embodiment that has been subjected to the chemical strengthening treatment is preferably 500 MPa or more, more preferably 600 MPa or more, and still more preferably 700 MPa or more, from the viewpoint of preventing cracks due to deformation such as deflection. The upper limit of the surface compressive stress is not particularly limited, and is, for example, 800 MPa or less. The value of the surface compressive stress can be adjusted based on, for example, a Na concentration in the molten salt or a Li concentration in the glass composition.

Note that, in the present description, the surface compressive stress (CS) can be measured by thinning a cross section of the crystallized glass and analyzing the thinned sample with a birefringence imaging system. Examples of the birefringence imaging system include a birefringence imaging system Abrio-IM manufactured by Tokyo Instruments Inc.

The surface compressive stress can also be measured using scattered light photoelasticity. In this method, light is incident from the surface of the crystallized glass, and polarization of scattered light thereof is analyzed to measure the CS. Examples of a stress measuring instrument using the scattered light photoelasticity include a scattered light photoelasticity stress meter SLP-1000 manufactured by Orihara Industrial Co., Ltd.

The depth of compressive stress layer (DOL) of the crystallized glass according to the present embodiment that has been subjected to the chemical strengthening treatment is preferably 70 μm or more, more preferably 80 μm or more, and still more preferably 100 μm or more, from the viewpoint of preventing cracks when scratches are generated on the surface of the crystallized glass. The upper limit of the depth of compressive stress layer is not particularly limited, and is, for example, 200 μm or less. The value of the depth of compressive stress layer can be adjusted based on a chemical strengthening time.

Note that, in the present description, a depth of compressive stress layer (DOL) is a depth at which the surface compressive stress (CS) is zero.

It is more preferable that the crystallized glass according to the present embodiment that has been subjected to the chemical strengthening treatment satisfies both a surface compressive stress of 500 MPa or more and a depth of compressive stress layer of 70 μm or more.

The internal tensile stress (CT) of the crystallized glass according to the present embodiment that has been subjected to the chemical strengthening treatment is preferably 50 MPa to 110 MPa, more preferably 55 MPa to 100 MPa, and still more preferably 60 MPa to 90 MPa. Here, the internal tensile stress is preferably 110 MPa or less, more preferably 100 MPa or less, and still more preferably 90 MPa or less, from the viewpoint of preventing scattering of fragments when the crystallized glass is fractured. In addition, the internal tensile stress is preferably 50 MPa or more, more preferably 55 MPa or more, and still more preferably 60 MPa or more, from the viewpoint of obtaining a sufficient surface compressive stress.

Note that, in the present description, the internal tensile stress (CT) means a tensile stress value at a depth of ½ (t×½) in a crystallized glass having a thickness t.

The value of ST limit of the crystallized glass according to the present embodiment that has been subjected to the chemical strengthening treatment is preferably 10,000 MPa·μm to 300,000 MPa·μm, more preferably 15,000 MPa·μm to 300,000 MPa·μm, and still more preferably 20,000 MPa·μm to 300,000 MPa·μm. Here, from the viewpoint of improving drop strength by the chemical strengthening treatment, the value of ST limit is preferably 10,000 MPa·μm or more, more preferably 15,000 MPa·μm or more, and still more preferably 20,000 MPa·μm or more, which is preferably as large as possible. The upper limit of the value of ST limit is not particularly limited, and is, for example, 300,000 MPa·μm or less. The value of ST limit can be adjusted based on the crystal species, the crystallinity, and the glass composition.

Note that, in the present description, the tensile stress integral value (ST value) refers to an area integral of tensile stress (negative compressive stress) with respect to a sample depth from the DOL to a depth of ½ of the thickness t. In the crystallized glass that has been subjected to the chemical strengthening treatment, when the ST value in the crystallized glass is a certain threshold value or more, the fragmentation number rapidly increases during fracture. The threshold value is referred to as the “ST limit”.

Specifically, the value of ST limit is determined by using the following test method.

### Test Method:

As a test glass sheet, a glass sheet having a 15 mm square and a thickness of 0.7 mm and having a mirror-finished surface is subjected to a chemical strengthening treatment under various conditions to prepare a plurality of test glass sheets having different ST values which are tensile stress integral values. Using a Vickers tester, a diamond indenter with a tip angle of 90° is driven into a central portion of the test glass sheet to fracture the glass sheet, and the number of broken pieces is defined as a fragmentation number, in a case where the glass sheet is not cracked after a test is started with a driving load of the diamond indenter of 1 kgf, the driving load is increased by 1 kgf each time, the test is repeated until the glass sheet is cracked, and the fragmentation number when the glass sheet is cracked for the first time is counted. The fragmentation number is plotted with respect to an ST value of the test glass sheet, and an ST value at which the fragmentation number is 10 is read and is regarded as the ST limit.

The fracture toughness value of the crystallized glass according to the present embodiment that has been subjected to the chemical strengthening treatment is preferably 0.8 MPa·m^{1/2} or more, and more preferably 1 MPa·m^{1/2} or more, from the viewpoint of preventing scattering of fragments when the crystallized glass is fractured. The upper limit of the fracture toughness value is not particularly limited, and is, for example, 2.0 MPa·m^{1/2} or less. The fracture toughness value can be adjusted based on the crystal species, the crystallinity, and the glass composition.

Note that, in the present description, the fracture toughness value means a value measured by using a single-edge-precracked-beam method (SEPB method) specified in JIS R1607:2015.

The Young's modulus of the crystallized glass according to the present embodiment that has been subjected to the chemical strengthening treatment is preferably 80 GPa or more, more preferably 86 GPa or more, still more preferably 90 GPa or more, and even still more preferably 100 GPa or more, from the viewpoint of preventing scattering of fragments when the crystallized glass is fractured. The upper limit of the Young's modulus is not particularly limited, and is, for example, 150 GPa or less.

Note that, the Young's modulus in the present description means a value determined by using an ultrasonic method.

The Vickers hardness of the crystallized glass according to the present embodiment that has been subjected to the chemical strengthening treatment is preferably 680 GPa or more, more preferably 720 GPa or more, and still more preferably 750 GPa or more, from the viewpoint of scratch resistance. The Vickers hardness is preferably as high as possible, and is generally 1,200 GPa or less.

Note that, the Vickers hardness in the present description means the Vickers hardness (HV 0.98 N) specified in JIS R1610:2003.

The haze value of the crystallized glass according to the present embodiment in terms of a thickness of 0.7 mm is preferably 0.4% or less, more preferably 0.3% or less, still more preferably 0.2% or less, and even more preferably 0.15% or less, from the viewpoint of visibility when the crystallized glass is used as a cover glass, particularly as a three-dimensionally shaped cover glass. The haze value is preferably as small as possible, and is generally 0.01% or more. The haze value of a general amorphous glass having no crystal phase is generally about 0.02%. The haze value can be adjusted based on the crystal species, the crystallinity, and the glass composition.

Note that, the haze value in the present description means a value measured in accordance with JIS K3761:2000 using a C light source. In the case where the actual thickness of the crystallized glass is not 0.7 mm, the haze value can be converted to a value at a thickness of 0.7 mm based on a measured value using the Lambert-Beer law. In addition, in the case of a crystallized glass having a thickness t of greater than 0.7 mm, the thickness may be adjusted to 0.7 mm by polishing, etching, or the like for the measurement.

The average transmittance of the crystallized glass according to the present embodiment with respect to light having a wavelength range of 380 nm to 780 nm in terms of a thickness of 0.7 mm is preferably 85% or more, more preferably 87% or more, and still more preferably 90% or more, from the viewpoint of visibility when the crystallized glass is used as a cover glass, particularly as a three-dimensionally shaped cover glass. The average transmittance is preferably as high as possible, and is generally 92% or less. Note that, when the light transmittance is 90% in terms of a thickness of 0.7 mm, the light transmittance is equivalent to that of a general amorphous glass. The average transmittance can be adjusted based on the crystal species, the crystallinity, and the glass composition.

The average transmittance in the present description means an average of linear transmittances with respect to light having a wavelength range of 380 nm to 780 nm. In the case where the actual thickness of the crystallized glass is not 0.7 mm, the transmittance can be converted to a value at a thickness of 0.7 mm based on a measured value using the Lambert-Beer law. In addition, in the case of a crystallized glass having a thickness t of greater than 0.7 mm, the thickness may be adjusted to 0.7 mm by polishing, etching, or the like for the measurement.

In the case where the crystallized glass according to the present embodiment has a flat sheet shape, the thickness (t) thereof is preferably 0.1 mm to 3 mm, more preferably 0.2 mm to 2 mm, still more preferably 0.3 mm to 1.6 mm, even more preferably 0.35 mm to 1.1 mm, even still more preferably 0.4 mm to 0.9 mm, and particularly preferably 0.5 mm to 0.7 mm. Here, the thickness is preferably 0.1 mm or more, more preferably 0.2 mm or more, still more preferably 0.3 mm or more, even more preferably 0.35 mm or more, even still more preferably 0.4 mm or more, and particularly preferably 0.5 mm or more, from the viewpoint of obtaining a sufficient strength. In addition, the thickness is preferably 3 mm or less, more preferably 2 mm or less, still more preferably 1.6 mm or less, even more preferably 1.1 mm or less, even still more preferably 0.9 mm or less, and particularly preferably 0.7 mm or less, from the viewpoint of a weight and the haze value.

The crystallized glass according to the present embodiment may not have a constant thickness, and may include a configuration in which the thickness is partially different.

### <Application>

The crystallized glass according to the present embodiment is useful as a cover glass for use in electronic devices such as mobile devices such as a mobile phone and a smart phone. Further, the crystallized glass is also useful for a cover glass of electronic devices such as a television, a personal computer, and a touch panel, an elevator wall surface, or a wall surface (full-screen display) of a construction such as a house and a building, which is not intended to be carried. In addition, the crystallized glass is also useful as a building material such as a window glass, a table top, an interior of an automobile, an airplane, or the like, and a cover glass thereof, or useful for a casing having a curved surface shape.

The crystallized glass according to the present embodiment is also suitably used for the above applications after being formed into a crystallized glass subjected to a chemical strengthening treatment.

Further, the crystallized glass according to the present embodiment is also suitably used as a three-dimensionally shaped cover glass having a three-dimensional shape including a curved surface portion forming a three-dimensional curved surface, and the crystallized glass that has been subjected to the chemical strengthening treatment is also suitably used as the three-dimensionally shaped cover glass.

These three-dimensionally shaped cover glasses are also used in the above applications.

### <Three-Dimensionally Shaped Cover Glass>

A three-dimensionally shaped cover glass according to the present embodiment can have a three-dimensional shape known in the related art. Here, the three-dimensional shape means a shape obtained by bending a flat sheet. Note that, the three-dimensional shape is not limited to a shape having a uniform thickness as a whole, and may be a shape having portions having different thicknesses.

Examples of the three-dimensional shape include a shape in which a central portion has a flat sheet shape and an end portion has a concave shape or a convex shape. In addition, the three-dimensional shape may include a shape in which the central portion does not have a flat sheet shape and the entire crystallized glass has a curved surface or a shape including a plurality of R shapes.

### <<Method for Producing Crystallized Glass>>

The crystallized glass according to the present embodiment can be produced by subjecting an amorphous glass to a heat treatment and crystallization. That is, the method for producing a crystallized glass according to the present embodiment includes the following steps.

Step 1: a step of producing an amorphous glass

Step 2: a step of subjecting the amorphous glass obtained in the step 1 to a crystallization treatment to obtain a crystallized glass

Step 3: a step of optionally subjecting the crystallized glass obtained in the step 2 to a chemical strengthening treatment

The three-dimensionally shaped cover glass according to the present embodiment is obtained by a production method further including the following step 4 in addition to the above step 1 to step 3.

Step 4: a step of imparting a curved surface forming a three-dimensional curved surface to the crystallized glass obtained in the step 2 or the step 3 to obtain a three-dimensionally shaped cover glass

Hereinafter, the steps are described.

### <Step 1>

The step 1 is a step of producing an amorphous glass, and a known method can be adopted as a specific method.

That is, in the case of obtaining a sheet-shaped amorphous glass, for example, glass raw materials are blended to have a desired composition and heated and melted in a glass melting furnace. Thereafter, the molten glass is homogenized by bubbling, stirring, addition of a refining agent, and the like, and formed into a glass sheet having a predetermined thickness by a known forming method, followed by annealing. Alternatively, the molten glass may be formed into a block shape, followed by annealing, and then cut into a sheet shape.

Examples of a method for forming a sheet-shaped glass include a float method, a press method, a fusion method, and a down-draw method.

The viscosity of the molten glass of a crystallization heat treatment is preferably 1×10⁴ dPa·s to 1×10¹² dPa·s, more preferably 1×10⁵ dPa·s to 1×10¹¹ dPa·s, and still more preferably 1×10⁶ dPa·s to 1×10¹⁰ dPa·s. Here, the viscosity is preferably 1×10⁴ dPa·s or more, more preferably 1×10⁵ dPa·s or more, and still more preferably 1×10⁶ dPa·s or more, from the viewpoint of realizing a high transmittance and a small haze value by preventing the crystal growth rate of the crystal constituting the crystal phase and keeping the average grain diameter (crystallite size) of the crystal small in the crystallization treatment in the subsequent step 2. In addition, the viscosity is preferably 1×10¹² dPa·s or less, more preferably 1×10¹¹ dPa·s or less, and still more preferably 1×10¹⁰ dPa·s or less, from the viewpoint of precipitating the crystal phase.

The viscosity can be adjusted based on the content proportion of the thickening component, that is, ZrO₂, Y₂O₃, TiO₂, and SnO₂.

In addition, the desired composition is the same as the preferred embodiment described in the above <<Crystallized Glass>>. For example, the content proportion in terms of mole percentage based on oxides preferably satisfies the following:
55% to 75% of SiO₂;
0.1% to 5% of Al₂O₃;
0.5% to 5% of P₂O₅;
0% to 10% of B₂O₃;
15% to 30% of Li₂O;
0% to 5% of Na₂O;
0% to 3% of K₂O;
2.1% to 10% of ZrO₂;
0% to 5% of TiO₂;
0% to 2% of SnO₂;
0% to 5% of Y₂O₃; and
0% to 5% of MgO.

In addition to the above, the value represented by the following expression (1) is more preferably 6 to 500.

Note that, in the expression (1), [SiO₂], [Li₂O], and [Al₂O₃] respectively represent the content proportions (mol %) of SiO₂, Li₂O, and Al₂O₃ in the crystallized glass, [LAS] represents a total content proportion (mol %) of SiO₂, Li₂O, and Al₂O₃ in the crystallized glass, and [A] represents a total content proportion (mol %) of the thickening components in the crystallized glass.

$$\begin{matrix}[ Math . 5 ] & \\ \frac{500}{\{ \begin{matrix}\vert \frac{[ {SiO}_{2} ]}{[ LAS ]} \times 100 - 66.7 \vert \times \vert \frac{[ {Li}_{2} O ]}{[ LAS ]} \times 100 - 33.3 \vert \times \\ ( \frac{[ {Al}_{2} {O}_{3} ]}{[ LAS ]} \times 100 )\end{matrix} \}} + [ A ] & ( 1 )\end{matrix}$$

### <Step 2>

The step 2 is a step of subjecting the amorphous glass obtained in the step 1 to a crystallization treatment to obtain a crystallized glass.

The heat treatment for the crystallization treatment is not particularly limited as long as the desired crystals are obtained, and may be, for example, a two-stage heat treatment in which the glass is heated from room temperature to a first treatment temperature and is held for a certain period of time, and then is held for a certain period of time at a second treatment temperature that is higher than the first treatment temperature. After the two-stage heat treatment, a three-stage heat treatment in which the glass is held at a third treatment temperature for a certain period of time may be performed. Alternatively, the heat treatment may be a one-stage heat treatment in which the glass is held at a specific treatment temperature and then cooled to room temperature.

In the case of the two-stage heat treatment, the first treatment temperature is preferably a temperature range in which a crystal nucleation rate increases in the glass composition. The second treatment temperature is preferably in a temperature range in which the crystal growth rate increases in the glass composition.

In the case of the three-stage heat treatment, it is preferable that the first treatment temperature and the second treatment temperature are set to a temperature at which the crystal nucleation rate increases, and the third treatment temperature is set to a temperature at which the crystal growth rate increases. In addition, the first treatment temperature may be set to a temperature at which the crystal nucleation rate increases, and the second treatment temperature and the third treatment temperature may be set to a temperature at which the crystal growth rate increases.

In the two-stage heat treatment and the three-stage heat treatment, the holding time at the first treatment temperature is preferably long such that a sufficient number of crystal nuclei are generated. When a large number of crystal nuclei are generated, a size of each crystal is reduced, and a crystallized glass having high transparency is obtained.

More specifically, in the case of the two-stage heat treatment, the glass is held at the first treatment temperature of, for example, 500 °C to 700 °C for 1 hour to 6 hours, and then held at the second treatment temperature of, for example, 600 °C to 800 °C for 1 hour to 6 hours.

More specifically, in the case of the three-stage heat treatment, the glass is held at the first treatment temperature of, for example, 500 °C to 600 °C for 1 hour to 6 hours, then held at the second treatment temperature of, for example, 550 °C to 650 °C for 1 hour to 6 hours, and further held at the third treatment temperature of, for example, 600 °C to 800 °C for 1 hour to 6 hours.

More specifically, in the case of the one-stage heat treatment, the glass is held at, for example, 500 °C to 800 °C for 1 hour to 6 hours.

The crystallized glass obtained in the step 2 may be ground and polished as necessary. In the case where the obtained crystallized glass is subjected to cutting into a predetermined shape and size or chamfering, the cutting or chamfering is preferably performed before the subsequent chemical strengthening treatment, which is the step 3, is performed. Accordingly, a compressive stress layer can also be formed on end surfaces, such as a cut surface and a chamfered surface, by the subsequent chemical strengthening treatment.

### <Step 3>

The step 3 is a step of subjecting the crystallized glass obtained in the step 2 to a chemical strengthening treatment, and is optional.

The chemical strengthening treatment is a treatment in which a glass is brought into contact with a metal salt by a method of immersing the glass into a melt of a metal salt (for example, potassium nitrate) containing metal ions (typically, Na ions or K ions) having a large ion radius, and thereby metal ions (typically, Li ions or Na ions) having a small ion radius in the glass are substituted with the metal ions having a large ion radius (typically, Na ions or K ions for Li ions, and K ions for Na ions).

In order to increase the rate of the chemical strengthening treatment, it is preferable to use “Li—Na exchange” in which Li ions in the glass are exchanged with Na ions. In addition, in order to form a large compressive stress by ion exchange, it is preferable to use “Na—K exchange” in which Na ions in the glass are exchanged with K ions.

Examples of the molten salt for performing the chemical strengthening treatment include a nitrate, a sulfate, a carbonate, and a chloride.

Examples of the nitrate include lithium nitrate, sodium nitrate, potassium nitrate, cesium nitrate, and silver nitrate.

Examples of the sulfate include lithium sulfate, sodium sulfate, potassium sulfate, cesium sulfate, and silver sulfate.

Examples of the carbonate include lithium carbonate, sodium carbonate, and potassium carbonate.

Examples of the chloride include lithium chloride, sodium chloride, potassium chloride, cesium chloride, and silver chloride.

These molten salts may be used alone or in combination of plural types thereof.

As treatment conditions of the chemical strengthening treatment, a time, a temperature, and the like can be selected in consideration of the glass composition, the type of the molten salt, and the like. For example, the crystallized glass can be subjected to the chemical strengthening treatment at preferably 500 °C or lower for preferably 20 hours or shorter. In addition, two or more stages of chemical strengthening treatment may be performed.

### <Step 4>

The step 4 is a step of imparting a curved surface forming a three-dimensional curved surface to the obtained crystallized glass to obtain a three-dimensionally shaped cover glass.

The curved surface can be imparted by using a known bending method. Examples of the bending method include a self-weight forming method, a vacuum forming method, and a press forming method. Two or more bending methods may be used in combination.

The self-weight forming method is a method in which a crystallized glass is placed on a forming mold, and then the crystallized glass is heated and fitted to the forming mold by gravity to be bent into a predetermined shape.

The vacuum forming method is a method in which a crystallized glass is placed on a forming mold, the periphery of the crystallized glass is sealed, then a space between the forming mold and the crystallized glass is depressurized, and a differential pressure is applied to front and back surfaces of the crystallized glass to perform bending. At this time, an upper surface side of the crystallized glass may be pressurized supplementarily.

The press forming method is a method in which a crystallized glass is placed between forming molds (a lower mold and an upper mold), the crystallized glass is heated, and a press load is applied between the upper and lower forming molds to bend the crystallized glass into a predetermined shape.

In any forming method, the crystallized glass is deformed by applying a force in a heated state.

A bending (thermal bending) temperature is, for example, 700 °C to 1,100 °C, and preferably 750 °C to 1,050 °C.

A difference between a maximum temperature of the crystallization treatment in the step 2 and the thermal bending temperature in the step 4 is preferably 10 °C to 120 °C, more preferably 10 °C to 100 °C, still more preferably 30 °C to 90 °C, and even more preferably 30 °C to 60 °C. Here, when the thermal bending temperature is higher than the maximum temperature of the crystallization treatment in the step 2, thermal deformation easily occurs, and thus, the difference between the maximum temperature of the crystallization treatment and the thermal bending temperature is preferably 10 °C or more, and more preferably 30 °C or more, from the viewpoint of realizing high dimensional accuracy. In addition, the difference in temperature is preferably 120 °C or less, more preferably 100 °C or less, still more preferably 90 °C or less, and even more preferably 60 °C or less, from the viewpoint of preventing a decrease in light transmittance due to the bending.

A decrease in average transmittance of the crystallized glass with respect to light having a wavelength range of 380 nm to 780 nm due to the bending is preferably 3% or less, more preferably 2% or less, still more preferably 1.5% or less, and even more preferably 1% or less, which is preferably as small as possible.

Alternatively, the crystallized glass obtained in the step 2 may be formed into a three-dimensionally shaped cover glass in the step 4 followed by being subjected to a chemical strengthening treatment in the step 3.

### EXAMPLES

Hereinafter, the present invention is described with reference to Examples, but the present invention is not limited thereto.

Note that, Example 1 to Example 15 are Inventive Examples.

### Example 1 to Example 15

Respective glass raw materials were blended so as to have the glass composition shown in Table 1 in mol % in terms of oxides, and weighed so as to obtain 400 g of glass. Next, the mixed glass raw materials were charged into a platinum crucible, followed by charging into an electric furnace at 1,500 °C, melted for about 5 hours, defoamed, and homogenized.

The obtained molten glass was poured into a mold, held at 500 °C for 2 hours, and then cooled to room temperature at a rate of 0.5 °C/min, to obtain a glass block.

Each of the obtained glass blocks was processed into a sheet shape of 50 mm×50 mm×1.5 mm and subjected to a two-stage crystallization treatment. Specifically, a first treatment and a second treatment were performed at the temperature and the holding time described in “Crystallization condition” in Table 1. Thereafter, the glass was cooled to room temperature to obtain a crystallized glass.

Note that, in Example 5, the obtained crystallized glass was immersed in a sodium nitrate molten salt (100%) at 450 °C for 4 hours to be subjected to a chemical strengthening treatment.

It was found that the content proportion of Na₂O in the surface of the obtained crystallized glass that had been subjected to the chemical strengthening treatment was 5.8 mol % higher than the content proportion of Na₂O in the thickness center of the crystallized glass.

The crystallized glass that had been subjected to the chemical strengthening treatment had a surface compressive stress (CS) of 540 MPa, a depth of compressive stress layer (DOL) of 119 μm, and a value of ST limit of 27,000 MPa·μm.

In addition, the fracture toughness values of the crystallized glass in Example 5 and the crystallized glass in Example 6 before the chemical strengthening treatment were both 1.3 MPa·m^{1/2}.

TABLE 1

| | | Example 1 | Example 2 | Example 3 | Example 4 | Example 5 | Example 6 | Example 7 |
|---|---|---|---|---|---|---|---|---|
| Glass | SiO₂ | 63 | 64 | 65 | 63 | 64 | 65 | 66 |
| composition | Al₂O₃ | 2.0 | 2.0 | 2.0 | 2.5 | 2.5 | 2.5 | 2.5 |
| (mol %) | P₂O₅ | 1.5 | 1.5 | 1.5 | 1.5 | 1.5 | 1.5 | 1.5 |
| | Li₂O | 26 | 25 | 24 | 26 | 25 | 24 | 23 |
| | Na₂O | 2.5 | 2.5 | 2.5 | 2.5 | 2.5 | 2.5 | 2.5 |
| | K₂O | 0.5 | 0.5 | 0.5 | 0.5 | 0.5 | 0.5 | 0.5 |
| | ZrO₂ | 4.5 | 4.5 | 4.5 | 4.5 | 4.5 | 4.5 | 4.5 |

| | | | | | | | |
|---|---|---|---|---|---|---|---|
| Expression (1) | 24 | 15 | 11 | 18 | 12 | 10 | 8 |
| [SiO₂]/[LAS] | 69 | 70 | 71 | 69 | 70 | 71 | 73 |
| [Al₂O₃]/[LAS] | 2 | 2 | 2 | 3 | 3 | 3 | 3 |
| [Li₂O]/[LAS] | 29 | 27 | 25 | 28 | 27 | 26 | 25 |
| Crystallization condition | 600 °C, 2 h | 600 °C, 2 h | 600 °C, 2 h | 600 °C, 2 h | 600 °C, 2 h | 600 °C, 2 h | 600 °C, 2 h |
| | 750 °C, 2 h | 750 °C, 2 h | 750 °C, 2 h | 750 °C, 2 h | 750 °C, 2 h | 750 °C, 2 h | 750 °C, 2 h |
| Precipitated crystal | LD | LD | LD | LD | LD | LD | LD |
| Young's modulus (GPa) | 104 | 103 | 103 | 104 | 103 | 103 | 102 |
| Haze value (%) | 0.23 | 0.20 | 0.36 | 0.20 | 0.18 | 0.20 | 0.22 |
| Average transmittance (%) | 89.5 | 90 | 85.3 | 90.2 | 90.5 | 90.2 | 89.3 |

| | | Example 8 | Example 9 | Example 10 | Example 11 | Example 12 | Example 13 | Example 14 | Example 15 |
|---|---|---|---|---|---|---|---|---|---|
| Glass | SiO₂ | 67 | 64 | 65 | 64 | 64 | 65 | 63 | 64 |
| composition | Al₂O₃ | 2.5 | 3.0 | 3.0 | 3.5 | 2.5 | 2.5 | 2.5 | 2.5 |
| (mol %) | P₂O₅ | 1.5 | 1.5 | 1.5 | 1.5 | 2.0 | 2.0 | 2.5 | 2.5 |
| | Li₂O | 22 | 24 | 23 | 24 | 24 | 23 | 24 | 23 |
| | Na₂O | 2.5 | 2.5 | 2.5 | 2.5 | 2.5 | 2.5 | 2.5 | 2.5 |
| | K₂O | 0.5 | 0.5 | 0.5 | 0.5 | 0.5 | 0.5 | 0.5 | 0.5 |
| | ZrO₂ | 4.5 | 4.5 | 4.5 | 4.5 | 4.5 | 4.5 | 4.5 | 4.5 |

| | | | | | | | | |
|---|---|---|---|---|---|---|---|---|
| Expression (1) | 7 | 11 | 8 | 9 | 12 | 10 | 12 | 10 |
| [SiO₂]/[LAS] | 74 | 70 | 71 | 70 | 70 | 71 | 70 | 71 |
| [Al₂O₃]/[LAS] | 3 | 3 | 3 | 4 | 3 | 3 | 3 | 3 |
| [Li₂O]/[LAS] | 24 | 26 | 25 | 26 | 27 | 26 | 27 | 26 |
| Crystallization condition | 600 °C, 2 h | 600 °C, 2 h | 600 °C, 2 h | 600 °C, 2 h | 600 °C, 2 h | 600 °C, 2 h | 600 °C, 2 h | 600 °C, 2 h |
| | 770 °C, 2 h | 750 °C, 2 h | 750 °C, 2 h | 730 °C, 2 h | 750 °C, 2 h | 750 °C, 2 h | 750 °C, 2 h | 750 °C, 2 h |
| Precipitated crystal | LD | LD | LD | LD | LD | LD | LD | LD |
| Young's modulus (GPa) | 102 | 100 | 100 | 99 | 99 | 100 | 98 | 97 |
| Haze value (%) | 0.30 | 0.25 | 0.31 | 0.34 | 0.27 | 0.31 | 0.30 | 0.34 |
| Average transmittance (%) | 86.8 | 89 | 86 | 85.5 | 88.6 | 85.8 | 86 | 85.4 |

### <<Evaluation>>

### <X-Ray Diffraction: Precipitated Crystal>

The powder X-ray diffraction of the crystallized glass was measured under the following conditions, and the precipitated crystal was identified by Rietveld analysis.

Measurement device: SmartLab manufactured by Rigaku Corporation

X-ray used: CuKα rays

Measurement range: 2θ=10° to 80°

Speed: 10°/min

Step: 0.02°

The results are shown in Table 1, and Examples 1 to 15 were each a crystallized glass having a lithium disilicate (LD) crystal. The content proportion of the LD crystal in the crystal phase was 80 vol % or more, and crystals other than the LD crystal were also found, but the specific crystal structure thereof was not able to be identified. The crystallinity of the crystallized glass was 20 vol % or more and 50 vol % or less.

### <Young's Modulus>

The Young's modulus of the crystallized glass was measured by an ultrasonic method using an ultrasonic thickness meter (trade name: 38DL, manufactured by Olympus Corporation). The results are shown in Table 1.

### <Haze Value>

The haze value of the crystallized glass under a C light source was measured using a haze meter (HZ-V3, manufactured by Suga Test Instruments Co., Ltd.), and was converted into a haze value at a thickness of 0.7 mm. The results are shown in Table 1.

### <Average Transmittance>

The glass was brought into close contact with an integrating sphere using an integrating sphere unit (150 mm InGaAs Int. Sphere) as a detector in a spectrophotometer (LAMBDA950, manufactured by PerkinElmer, Inc.), and the transmittance of the crystallized glass at a wavelength range of 380 nm to 780 nm was measured. Then, an arithmetic average value of the obtained transmittances at the respective wavelengths was set as the average transmittance and converted into an average transmittance at a thickness of 0.7 mm. The results are shown in Table 1.

As seen from the above results, the crystallized glass according to the present embodiment can achieve both a high average transmittance and a small haze value by appropriately controlling the total content proportion of the thickening components without actively containing a crystal other than the LD crystal.

In addition, since the crystallized glass according to the present embodiment has a small content proportion of the crystal other than the LD crystal, a large Young's modulus can be realized and a high strength crystallized glass can be obtained. In addition, since the content proportion of the crystal other than the LD crystal can be reduced, high three-dimensional formability can also be achieved.

Further, the crystallized glasses in Example 1 to Example 15 are not subjected to a chemical strengthening treatment, but the LD crystal is a crystal capable of ion exchange between Li ions in the crystal and Na ions in the molten salt by the chemical strengthening treatment. Therefore, it can be said that the chemical strengthening treatability is excellent, and it is possible to further increase the strength by the ion exchange.

Although the present invention has been described in detail with reference to the specific embodiment, it is apparent to those skilled in the art that various changes and modifications can be made without departing from the spirit and scope of the present invention. The present application is based on a Japanese Patent Application (Japanese Patent Application No. 2023-221645) filed on Dec. 27, 2023, the content of which is incorporated herein by reference.

What is claimed is:

1. A crystallized glass having a crystal phase, comprising, as a content proportion in terms of mole percentage based on oxides:
55% to 75% of SiO₂;
0.1% to 5% of Al₂O₃;
0.5% to 5% of P₂O₅;
0% to 10% of B₂O₃;
15% to 30% of Li₂O;
0% to 5% of Na₂O;
0% to 3% of K₂O;
2.1% to 10% of ZrO₂;
0% to 5% of TiO₂;
0% to 2% of SnO₂;
0% to 5% of Y₂O₃; and
0% to 5% of MgO, wherein
the crystallized glass has a haze value of 0.4% or less in terms of a thickness of 0.7 mm, an average transmittance of 85% or more with respect to light having a wavelength range of 380 nm to 780 nm in terms of a thickness of 0.7 mm, and a value represented by the following expression (1) of 6 to 500,
$$\begin{matrix}[ Math . 1 ] & \\ \frac{500}{\{ \begin{matrix}\vert \frac{[ {SiO}_{2} ]}{[ LAS ]} \times 100 - 66.7 \vert \times \vert \frac{[ {Li}_{2} O ]}{[ LAS ]} \times 100 - 33.3 \vert \times \\ ( \frac{[ {Al}_{2} {O}_{3} ]}{[ LAS ]} \times 100 )\end{matrix} \}} + [ A ] & ( 1 )\end{matrix}$$
where in the expression (1), [SiO₂], [Li₂O], and [Al₂O₃] respectively represent the content proportions (mol %) of SiO₂, Li₂O, and Al₂O₃ in the crystallized glass, [LAS] represents a total content proportion (mol %) of SiO₂, Li₂O, and Al₂O₃ in the crystallized glass, and [A] represents a total content proportion (mol %) of a thickening component in the crystallized glass.

2. The crystallized glass according to claim 1, satisfying a relationship of 66≤[{[SiO₂]/([SiO₂]+[Al₂O₃]+[Li₂O])}×100] (%)≤77, where [SiO₂], [Li₂O], and [Al₂O₃] respectively represent the content proportions of SiO₂, Li₂O, and Al₂O₃ in the crystallized glass in terms of mole percentage based on oxides.

3. The crystallized glass according to claim 1, satisfying a relationship of 1≤[{[Al₂O₃]/([SiO₂]+[Al₂O₃]+[Li₂O])}×100] (%)≤5, where [SiO₂], [Li₂O], and [Al₂O₃] respectively represent the content proportions of SiO₂, Li₂O, and Al₂O₃ in the crystallized glass in terms of mole percentage based on oxides.

4. The crystallized glass according to claim 1, wherein
the crystal phase contains a Li₂Si₂O₅ crystal, and has a content proportion of the Li₂Si₂O₅ crystal being 50 vol % or more.

5. The crystallized glass according to claim 4, wherein the crystal phase has a content proportion of a crystal other than the Li₂Si₂O₅ crystal being 20 vol % or less.

6. The crystallized glass according to claim 1, comprising:
a Li ion capable of ion exchange with a Na ion when the crystallized glass is immersed in a molten salt containing the Na ion.

7. The crystallized glass according to claim 1, wherein a content proportion of Na₂O on a surface of the crystallized glass is greater than a content proportion of Na₂O at a thickness center of the crystallized glass in terms of mole percentage based on oxides, and a difference between the content proportion of Na₂O on the surface of the crystallized glass and the content proportion of Na₂O at the thickness center of the crystallized glass is 1% or more.

8. The crystallized glass according to claim 7, having a surface compressive stress of 500 MPa or more and a depth of compressive stress layer of 70 μm or more.

9. The crystallized glass according to claim 7, having a fracture toughness value of 0.8 MPa·m^{1/2} or more.

10. The crystallized glass according to claim 7, having a value of ST limit obtained by the following test method being 10,000 MPa·μm to 300,000 MPa·μm,
Test Method:
as a test glass sheet, a glass sheet having a 15 mm square and a thickness of 0.7 mm and having a mirror-finished surface is subjected to a chemical strengthening treatment under various conditions to prepare a plurality of test glass sheets having different ST values which are tensile stress integral values; using a Vickers tester, a diamond indenter with a tip angle of 90° is driven into a central portion of the test glass sheet to fracture the glass sheet, and the number of broken pieces is defined as a fragmentation number, in a case where the glass sheet is not cracked after a test is started with a driving load of the diamond indenter of 1 kgf, the driving load is increased by 1 kgf each time, the test is repeated until the glass sheet is cracked, and the fragmentation number when the glass sheet is cracked for the first time is counted; and the fragmentation number is plotted with respect to an ST value of the test glass sheet, and an ST value at which the fragmentation number is 10 is read and is regarded as the ST limit.

11. A three-dimensionally shaped cover glass comprising:
the crystallized glass according to claim 1, wherein
the crystallized glass has a three-dimensional shape including a curved surface portion forming a three-dimensional curved surface.
